(19) United States
(12) Patent Application Publication
(10) Pub. No.: US 2021/0263366 A1
(43) Pub. Date: Aug. 26, 2021

(54) Display Panel Driving Chip, Display Panel Driving Structure and Display Device Thereof

(71) Applicant: Sitronix Technology Corp., Hsinchu County (TW)

(72) Inventors: Kai-Yi Wu, Hsinchu County (TW); Yun-Chu Chen, Hsinchu County (TW); Li-Yu Huang, Hsinchu County (TW)

(21) Appl. No.: 17/017,707

(22) Filed: Sep. 11, 2020

Related U.S. Application Data
(60) Provisional application No. 62/898,555, filed on Sep. 11, 2019.

(51) Int. Cl. G02F 1/1345; G09G 3/36; G02F 1/1362

(52) U.S. Cl. CPC G02F 1/13452; G09G 3/3677; G09G 2310/0243; G02F 1/136286; G09G 3/3688

(57) ABSTRACT

A display panel driving chip includes a plurality of gate signal output ports and a plurality of source signal output ports. The source signal output ports outputting a plurality of source signals and the gate signal output ports outputting a plurality of gate signals are interleaved.

### CROSS REFERENCE TO RELATED APPLICATION

This application claims the benefit of U.S. Provisional Application No. 62/898,555, filed on Sep. 11, 2019 and entitled “DISPLAY PANEL”, the content of which is incorporated herein by reference.

### BACKGROUND OF THE INVENTION

### 1. Field of the Invention

The present invention relates to a display panel driving chip, display panel driving structure and display device thereof, and more particularly, to a display panel driving chip, display panel driving structure and display device thereof having narrow borders.

### 2. Description of the Prior Art

Many electronic devices include display panels and display panel driving chips, to present images to users. The display panel may be defined with a non-display area (also called a border) and a display area, and a display panel driving chip may be located in the non-display area, such as the non-display area located on the lower side of the display panel. The display panel driving chip utilizes source lines and gate lines to transmit source signals and gate signals to drive the display panel. In order to transmit the gate signals from the display panel driving chip to the display area of the display panel, gate lines run from the non-display area on the lower side of the display panel and through the non-display area of the left or right side of the display panel, to cross the display area. Since the gate lines are distributed in the non-display areas on the left and right sides of the display panel, the non-display areas on the left and right sides of the display panel are wider, which results in a wider border of the electronic device and reduces the range of the display area, thereby reducing the range of the display panel that can display images.

Under a situation of improving the resolution of the display panel or driving a large-size display panel, the electronic device may include two (or more) display panel driving chips, such as a first display panel driving chip and a second display panel driving chip. The first display panel driving chip and the second display panel driving chip may be located in a non-display area, such as a non-display area of a lower side, and are adjacent to each other. However, based on the consideration of wiring space, the gate lines routing from the non-display area of the lower side and through the non-display area on the left side are only electrically connected to a portion of the gate signal output ports of the first display panel driving chip. A position of the gate signal output port is far away from an adjacent area of the first display panel driving chip and the second display panel driving chip. That is, gate signal output ports of the first display panel driving chip close to the adjacent area are not electrically connected with any gate line. Similarly, based on wiring space considerations, gate lines routing from the non-display area on the lower side and through the non-display area on the right side are only electrically connected with gate signal output ports of the second display panel driving chip away from the adjacent area. Gate signal output ports close to the adjacent area are not electrically connected to any gate line. In other words, a portion of both the gate signal output ports of the first display panel driving chip and the second display panel driving chip are not fully utilized. Currently, there is the development of gate driver in panel (GIP) technology, which may reduce the non-display area and achieve the purpose of narrow border, but the GIP circuit needs to consume more power, which increases the demand for power.

In order to prevent the electronic device from losing beauty and increasing the volume and weight, the non-display area of the display panel should be adjusted to minimize the non-display area where no image is displayed, and maximize the display area where the image is displayed.

### SUMMARY OF THE INVENTION

It is therefore an objective of the present invention to provide a display panel driving chip, display panel driving structure and display device thereof capable of reducing the range of the non-display area to achieve the purpose of narrow borders, increasing the range of the display area, and consuming less power than GIP technology.

The present invention discloses a display panel driving chip. The display panel driving chip includes a plurality of gate signal output ports and a plurality of source signal output ports. The source signal output ports outputting a plurality of source signals and the gate signal output ports outputting a plurality of gate signals are interleaved.

The present invention further discloses a display panel driving structure. The display panel driving structure includes a plurality of display panel driving chips for driving a plurality of display areas of a display panel. Each display panel driving chip includes a plurality of gate signal output ports outputting a plurality of gate signals; and a plurality of source signal output ports outputting a plurality of source signals, wherein the source signal output ports and the gate signal output ports are interleaved.

The present invention further discloses a display device. The display device includes a display panel. The display panel includes at least one display area, and includes a plurality of gate lines; a plurality of source lines; and a plurality of connecting lines, passing through the at least one display area and respectively coupled to the gate lines, wherein an arrangement direction of the connecting lines located in the at least one display area is the same with an arrangement direction of the source lines.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 to FIG. 6 are schematic diagrams of display devices according to embodiments of the present invention.

### DETAILED DESCRIPTION

Certain terms are used throughout the following description/claims to refer to particular components. Manufacturers may refer to a component by different names. Therefore, components shall be distinguished according to function instead of name. In the following description/claims, the terms “include” and “comprise” are used in an open-ended fashion; thus, should be interpreted to mean “include/comprise but not limited to”. Also, the term “couple” is intended to mean either an indirect or direct electrical connection. If one device is coupled to another device, the connection may belong to a direct electrical connection or an indirect electrical connection via other devices and connections.

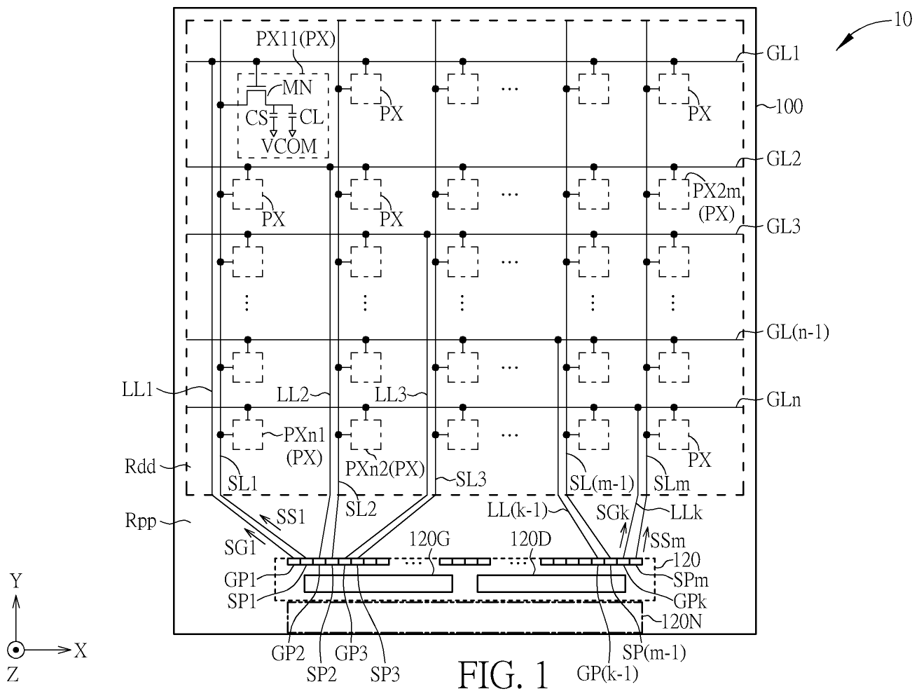

FIG. 1 is a diagram of a display device 10 according to an embodiment of the present invention. The display device 10 may include a display panel 100 and a display panel driving chip 120. The display panel 100 may include connecting lines LL1-LLK, source lines SL1-SLm, gate lines GL1-GLn and sub-pixels PX arranged in an array, wherein k, m, n are positive integers. The display panel driving chip 120 may include source signal output ports SP1-SPm, gate signal output ports GP1-GPk, a gate driving circuit 120G and a source driving circuit 120D. The gate lines GL1-GLn are respectively coupled to the connecting lines LL1-LLk. The connecting lines LL1-LLK are routed through a display area Rdd of the display panel 100 and are respectively electrically coupled between the gate lines GL1-GLn and the gate signal output ports GP1-GPk of the display panel driving chip 120, such that the gate signal output ports GP1-GPk are coupled to the gate lines GL1-GLn through the connecting lines LL1-LLk, and the gate signal output ports GP1-GPk are coupled to the gate driving circuit 120G. The source lines SL1-SLm are respectively coupled to the source signal output ports SP1-SPm, and the source signal output ports SP1-SPm are coupled to the source driving circuit 120D.

Briefly, the gate signal output ports GP1-GPk and the source signal output ports SP1-SPm are mutually interleaved. Thus, the source lines SL1-SLm extend to the display area Rdd without crossing any of the connecting lines LL1-LLK, such that the source lines SL1-SLm do not overlap any of the connecting lines LL1-LLk in a direction Z. The connecting lines LL1-LLK may be respectively coupled between the gate lines GL1-GLn of the display panel 100 and the display panel driving chip 120 in shortest paths. A segment of each of the connecting lines LL1-LLK may be located in the display area Rdd of the display panel 100. Another segment (of each of the connecting lines LL1-LLK) may be located in the same non-display area Rpp of the display panel 100 (e.g., the non-display area Rpp located on the lower side of the display panel 100 in FIG. 1), but may not be located in other non-display areas Rpp of the display panel 100 (e.g., the non-display areas Rpp located on the left, right and upper sides of the display panel 100 in FIG. 1), thereby achieving narrow borders.

Specifically, the display panel 100 may be defined as (or divided into) the display area Rdd and the non-display areas Rpp. The non-display areas Rpp may be located on at least one side of the display area Rdd, such that the non-display areas Rpp may surround or enclose the display area Rdd.

The connecting lines LL1-LLk and the source lines SL1-SLm of the display panel 100 are respectively disposed in the display area Rdd and the non-display area Rpp. An arrangement direction of the connecting lines LL1-LLK in the display area Rdd of the display panel 100 is the same as an arrangement direction of the source lines SL1-SLm of the display panel 100. For example, in the display area Rdd of the display panel 100, the connecting lines LL1-LLk and the source lines SL1-SLm may extend substantially in a direction Y and are substantially parallel to each other. The gate lines GL1-GLn are respectively disposed in the display area Rdd. The gate lines GL1-GLn may extend substantially in a direction X and are substantially perpendicular to the source lines SL1-SLm or the connecting lines LL1-LLk. The gate lines GL1-GLn may be disposed in a first metal layer of the display panel 100. The connecting lines LL1-LLk may be disposed in a second metal layer of the display panel 100. The source lines SL1-SLm may be disposed in a third metal layer of the display panel 100. The first metal layer and the second metal layer may be different metal layers. The first metal layer and the third metal layer may be different metal layers. The second metal layer and the third metal layer may be the same layer or different metal layers. In the display area Rdd of the display panel 100, vias may be utilized for the connecting lines LL1-LLK to be electrically connected to the gate lines GL1-GLn, and therefore the connecting lines LL1-LLK may be located only in the non-display area Rpp on one side of the display panel 100. For example, the connecting lines LL1-LLK may be located merely in the non-display area Rpp on the lower side of the display panel 100 in FIG. 1, and thus the non-display areas Rpp located on the left, right and upper sides of the display panel 100 may be minimized to achieve narrow borders.

The sub-pixels PX or other (touch or fingerprint recognition) sensing electrodes of the display panel 100 may be disposed in the display area Rdd. The sub-pixels PX located in the display area Rdd may be used to display images. In each junction of the gate lines GL1-GLn and the source lines SL1-SLm, the corresponding one of the gate lines GL1-GLn and the corresponding one of the source lines SL1-SLm are respectively coupled to a transistor MN of the sub-pixel PX. Each of the transistors MN is coupled to capacitors CS and CL of the corresponding sub-pixel PX. The capacitor CL represents an equivalent capacitor (also referred to as a liquid crystal capacitor) of the corresponding sub-pixel PX in the display panel 100, which is equivalently coupled between a pixel electrode and a common electrode VCOM. A common voltage of the common electrode VCOM is a reference voltage of the sub-pixel PX. The voltage difference between the voltage of the pixel electrode and the common voltage may determine the gray level of the sub-pixel PX. Each sub-pixel PX of the display panel 100 may independently change the gray level by changing the voltage of the pixel electrode. The capacitor CS is a storage capacitor, and may or may not be coupled to the common electrode VCOM of the display device 10.

In the display area Rdd of the display panel 100, the connecting lines LL1-LLK and the source lines SL1-SLm are disposed between two adjacent sub-pixels respectively. For example, the connecting line LL2 is disposed between the subpixels PXn1, PXn2. A source line (e.g., the source line SL1) and a connecting line (e.g., the connecting line LL1), which are coupled to the same sub-pixel (e.g., the sub-pixel PX11), may be located on the same side (e.g., left side) of the sub-pixel (e.g., the sub-pixel PX11). A connecting line (e.g., the connecting line LL2) may be a first distance away from an adjacent source line (e.g., the source line SL1), and a second distance away from another adjacent source line (e.g., the source line SL2). The first distance is not equal to (e.g., greater than) the second distance.

The display panel driving chip 120 of the display device 10 may be disposed in the non-display area Rpp of the display panel 100 or not disposed in the display panel 100. The gate driving circuit 120G of the display panel driving chip 120 may be a gate driver, and may generate gate signals SG1-SGk according to a timing signal from a timing controller (not shown). The display panel driving chip 120 may output the gate signals SG1-SGk to the gate lines GL1-GLn through the gate signal output ports GP1-GPk to control conduction of the transistors MN, thereby controlling update timing of the sub-pixels PX in each row. The source driving circuit 120D of the display panel driving chip 120 may be a source driver, and may generate the source signals SS1-SSm according to the timing signal. The display panel driving chip 120 outputs the source signals SS1-SSm to the source lines SL1-SLm of the display panel 100 through the source signal output ports SP1-SPm to transmit the source signals SS1-SSm to the corresponding subpixels PX. Accordingly, the display panel driving chip 120 may control the pixel voltage of each sub-pixel PX to control rotation angle(s) (or alignments) of liquid crystals. In some embodiments, the display panel driving chip 120 may include the aforementioned timing controller.

The gate signal output ports GP1-GPk and the source signal output ports SP1-SPm of the display panel driving chip 120 may be bond pads/pins respectively. To achieve narrow borders, the gate signal output ports GP1-GPk or/and the source signal output ports SP1-SPm are discretely distributed instead of being narrowly distributed, thereby relatively reducing the non-display area Rpp and relatively increasing the display area Rdd. For example, the gate signal output ports GP1-GPk or/and the source signal output ports SP1-SPm may be discretely interleaved. In FIG. 1, at least one gate signal output port (e.g., the gate signal output port GP2) is disposed between any two adjacent or closest ones of the source signal output ports (e.g., the signal source output ports SP1, SP2), such that the source signal output ports SP1-SPm are not closely adjacent. At least one source signal output port (e.g., the source signal output port SP1) is disposed between any two adjacent or closest ones of the gate signal output ports (e.g., the gate signal output ports GP1, GP2), such that the gate signal output ports GP1-GPk are not closely adjacent. That is, the gate signal output ports GP1-GPk and the source signal output ports SP1-SPm are alternately arranged.

The gate signal output ports GP1-GPk of the display panel driving chip 120 may be sequentially arranged according to the row numbers of the gate lines GL1-GLn coupled to the gate signal output ports GP1-GPk. For example, the gate line GL1 is located in the first row, the gate line GL2 is located in the second row, and the gate line GL3 is located in the third row. Therefore, the gate signal output ports GP1, GP2, and GP3 are sequentially arranged in an ascending order of the row numbers from left to right. However, the present invention is not limited to this. The gate signal output ports GP1-GPk may be sequentially arranged in a descending order according to the row numbers of the gate lines GL1-GLn coupled to the gate signal output ports GP1-GPk. Similarly, the source signal output ports SP1-SPm are sequentially arranged in an ascending or descending order according to the column numbers of the source lines SL1-SLm electrically connected to the source signal output ports SP1-SPm. That is, the arrangement of the gate signal output ports GP1-GPk or the source signal output ports SP1-SPm may be related to a sequence of the row numbers or the column numbers. Correspondingly, the number of the gate signal output ports GP1-GPk may be the same as the number of the gate lines GL1-GLn; that is, k=n.

The gate signal output ports GP1-GPk and the source signal output ports SP1-SPm of the display panel driving chip 120 may be aligned. That is, the upper edge (or the lower edge) of one gate signal output port (e.g., the gate signal output port GP1) may be aligned with the upper edge (or the lower edge) of the source signal output ports SP1-SPm or other gate signal output ports (e.g., the gate signal output ports GP2-GPk). Two closely adjacent ones of the gate signal output ports GP1-GPk and the source signal output ports SP1-SPm may be separated by a distance. For example, the gate signal output port GP1 and the source signal output port SP1 are closely adjacent and separated by a distance.

The display panel driving chip 120 may be disposed on the display panel 100 in the form of chip on glass (COG). The display panel driving chip 120 may include a bonding area 120N located in the non-display area Rpp of the display panel 100. The bonding area 120N is utilized for inner lead bonding (ILB), for example, to bond pins of a flexible printed circuit (FPC) board. Accordingly, the display panel driving chip 120 may be coupled to the processing circuit such as a microprocessor or application-specific integrated circuit (ASIC).

The aforementioned is an exemplary embodiment of the present invention. Those skilled in the art may readily make different modifications. For example, the transistors MN of the display panel 100 may be thin film transistors (TFT). In FIG. 1, the display panel 100 is a liquid crystal display (LCD) panel to serve as an example. In other embodiments, the display panel 100 may be a fluorescent, phosphor, light emitting diode (LED), quantum dot (QD), or other suitable display panel, but is not limited thereto. The light emitting diode may include, for example, an organic light-emitting diode (OLED), inorganic light-emitting diode, micro light-emitting diode (micro-LED), mini-LED, QD LED (e.g., QLED, QDLED), other suitable materials, or any combination thereof, but is not limited thereto. The display device 10 may be, for example, a TFT LCD, which may be adopted in electronic products capable of displaying images—e.g., a laptop, a smart phone, and so on.

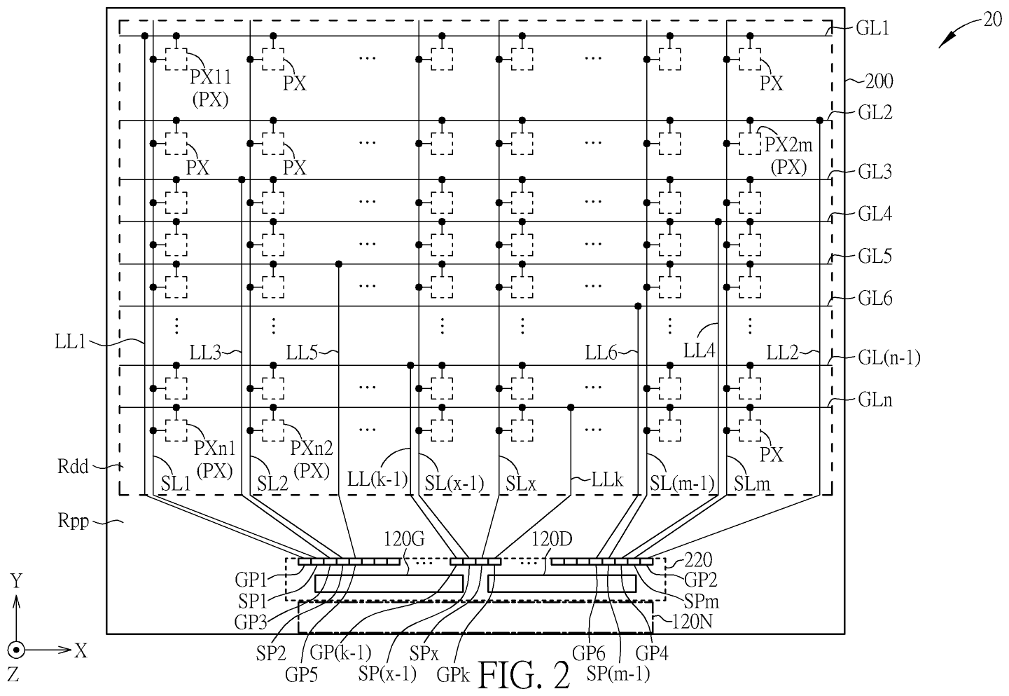

The arrangement of the gate signal output ports GP1-GPk and the source signal output ports SP1-SPm may be adjusted according to different design considerations, for example, according to the arrangement of the connecting lines LL1-LLk and the source lines SL1-SLm. FIG. 2 is a diagram of a display device 20 of an embodiment of the present invention. A display panel 200 of the display device 20 is substantially similar to the display panel 100; a display panel driving chip 220 of the display device 20 is substantially similar to the display panel driving chip 120. The same numerals/notations denote the same components in the following description.

In FIG. 2, the gate signal output ports GP1-GPk of the display device 20 are sequentially arranged according to even row numbers and odd row numbers of the gate lines GL1-GLn coupled to the gate signal output ports GP1-GPk. That is, the gate signal output ports GP1, GP3, . . . , GP(k−1) are coupled to the gate lines GL1, GL3, . . . , GL(n−1) located in odd rows, such that the gate signal output ports GP1, GP3, . . . , GP(k−1) are sequentially arranged in an ascending order from left to right according to the odd row numbers, where k is an even number. The gate signal output ports GPk, . . . , GP4, GP2 are coupled to the gate lines GLn, . . . , GL4, GL2 located in even rows, such that the gate signal output ports GPk, . . . , GP4, GP2 are sequentially arranged in an descending order from left to right according to the even row numbers. The gate signal output ports GP1, GP3, . . . , GP(K−1) coupled to the gate lines GL1, GL3, . . . , GL(n−1) of odd row numbers are sequentially arranged on one side (such as the left side) of the display panel driving chip 220, and the gate signal output ports GPk, . . . , GP4, GP2 coupled to the gate lines GLn, . . . , GL4, GL2 of even row numbers are sequentially arranged on another side (such as the right side) of the display panel driving chip 220. In FIG. 2, one source signal output port (e.g., the source signal output port SP1) is disposed between two adjacent ones of the gate signal output ports (e.g., the gate signal output ports GP1, GP3). Alternatively, two source signal output ports (e.g., the source signal output ports SP(x−1), SPx) are disposed between two adjacent ones of the gate signal output ports (e.g., the gate signal output ports GP(K−1), GP(k)). One gate signal output port (e.g., the gate signal output port GP3) is disposed between two adjacent ones of the source signal output ports (e.g., the source signal output ports SP1, SP2). Alternatively, there is no gate signal output port disposed between two adjacent ones of the source signal output ports (e.g., the source signal output ports SP(x−1), SPx). That is, the gate signal output ports GP1-GPk or the source signal output ports SP1-SPm may be interleaved in an irregular way.

In FIG. 2, a source line (e.g., the source line SL1) and a connecting line (e.g., the connecting line LL1) both coupled to the same sub-pixel (e.g., the sub-pixel PX11) may be located on the same side (e.g., the left side) of the sub-pixel (e.g., the sub-pixel PX11). Alternatively, a source line (e.g., the source line SLm) and a connecting line (e.g., the connecting line LL2) coupled to the same sub-pixel (e.g., the sub-pixel PX2m) may be located on different sides (or opposite sides) of the sub-pixel (e.g., the sub-pixel PX2m).

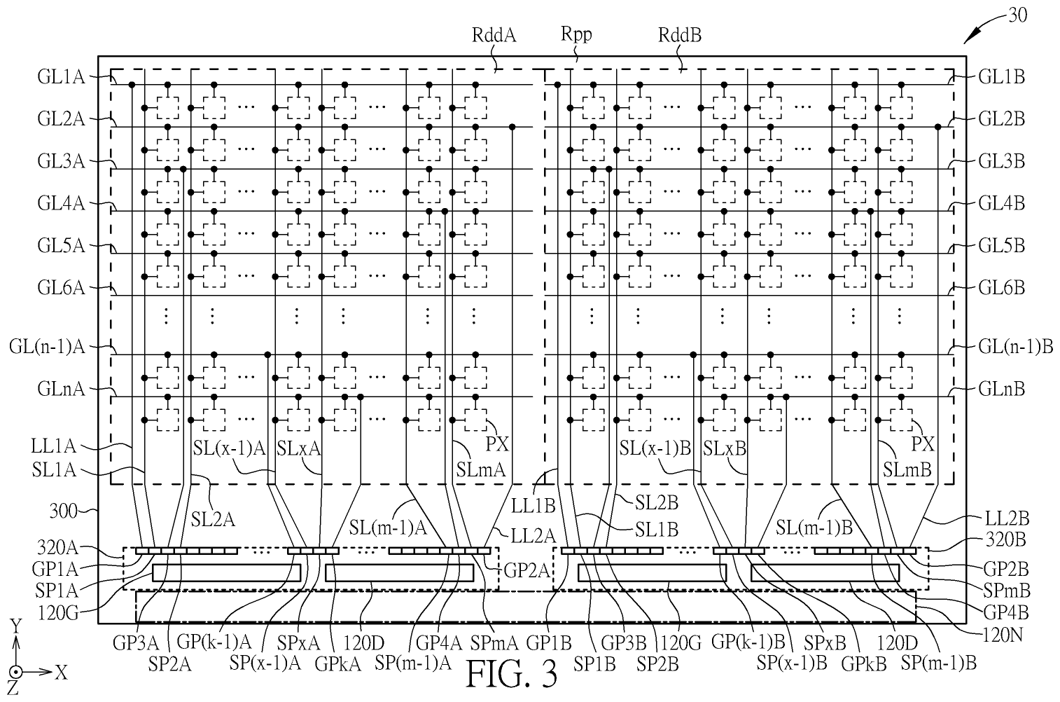

To increase the display size, the display device may include display panel driving chips. For example, FIG. 3 is a diagram of a display device 30 of an embodiment of the present invention. A display panel 300 of the display device 30 may be divided into two display areas RddA, RddB. The display device 30 may include two display panel driving chips 320A and 320B configured for driving the display areas RddA and RddB of the display panel 300, respectively. The configuration of the display areas RddA, RddB are substantially similar to the configuration of the display area Rdd, respectively. The display panel driving chips 320A, 320B are substantially similar to the display driving panel chip 220, respectively. In some embodiments, the configuration of the display device 30 may increase the resolution (e.g., up to two times more). For example, even if the size of the display panel 30 is the same as that of another display panel, the display panel 30 may be divided into more display areas, and the number of gate lines and source lines of the display panel 30 is larger.

The display panel driving chips 320A, 320B may individually drive the closely adjacent display areas RddA and RddB of the display panel 300. Gate signal output ports GP1A-GPkA of the display panel driving chip 320A may be coupled to gate lines GL1A-glnA of the display area RddA corresponding to the gate signal output ports GP1A-GPkA via connecting lines LL1A-LLkA respectively. Source signal output ports SP1A-SPmA of the display panel driving chip 320A are coupled to source lines SL1A-SLMA of the display area RddA corresponding to the source signal output ports SP1A-SPmA respectively. Gate signal output ports GP1B-GPkB of the display panel driving chip 320B are coupled to gate lines GL1B-glnB of the corresponding display area RddB corresponding to the gate signal output ports GP1B-GPkB through connecting lines LL1B-LLkB respectively. Source signal output ports SP1B-SPmB of the display panel driving chip 320B are coupled to source lines SL1B-SLmB of the display area RddB corresponding to the source signal output ports SP1B-SPmB respectively.

The gate signal output ports GP1A-GPkA and the source signal output ports SP1A-SPMA of the display panel driving chip 320A are mutually interleaved; the gate signal output ports GP1B-GPkB and the source signal output ports SP1B-SPmB of the display panel driving chip 320B are mutually interleaved. Thus, even if the display device 30 includes the two display panel driving chips 320A and 320B, the connecting lines LL1A-LLkA and LL1B-LLkB may directly extend through the display areas RddA and RddB respectively to achieve narrow borders. In some embodiments, the subpixels PX of the display areas RDDA, RddB are distributed continuously, such that there is no clear boundary between the display areas RDDA, RddB.

In FIG. 3, the gate lines GL1A-glnA in the display area RddA are not connected to the gate lines GL1B-glnB in the display area RddB; that is, the display area RddA and the display area RddB do not share any gate line. Therefore, the loads for the display panel driving chips 320A and 320B to transmit gate signals may be reduced to reduce power consumption. In some embodiments, each of the gate lines (e.g., the gate line GL1A) in the display area RddA is aligned with one of the gate lines (e.g., the gate line GL1B) in the display area RddB. One gate line (e.g., the gate line GL1A) coupled to one connecting line (e.g., the connecting line LL1A) in the display area RddA may be located in the same row as one gate line (e.g., the gate line GL1B) coupled to one connecting line (e.g., the connecting line LL1B) in the display area RddB. That is, one gate signal output port (e.g., the gate signal output port GP1A) of the display panel driving chip 320A and one gate signal output port (e.g., the gate signal output port GP1B) of the display panel driving chip 320B are coupled to different gate lines (e.g., the gate lines GL1A, GL1B) in the same row. The transistors MN located in the same row may not be driven by the same gate line, but may be driven by different gate lines (such as the gate lines GL1A, GL1B) located in the same row. Therefore, the output power of one gate signal output port (e.g., the gate signal output port GP1A) may be decreased.

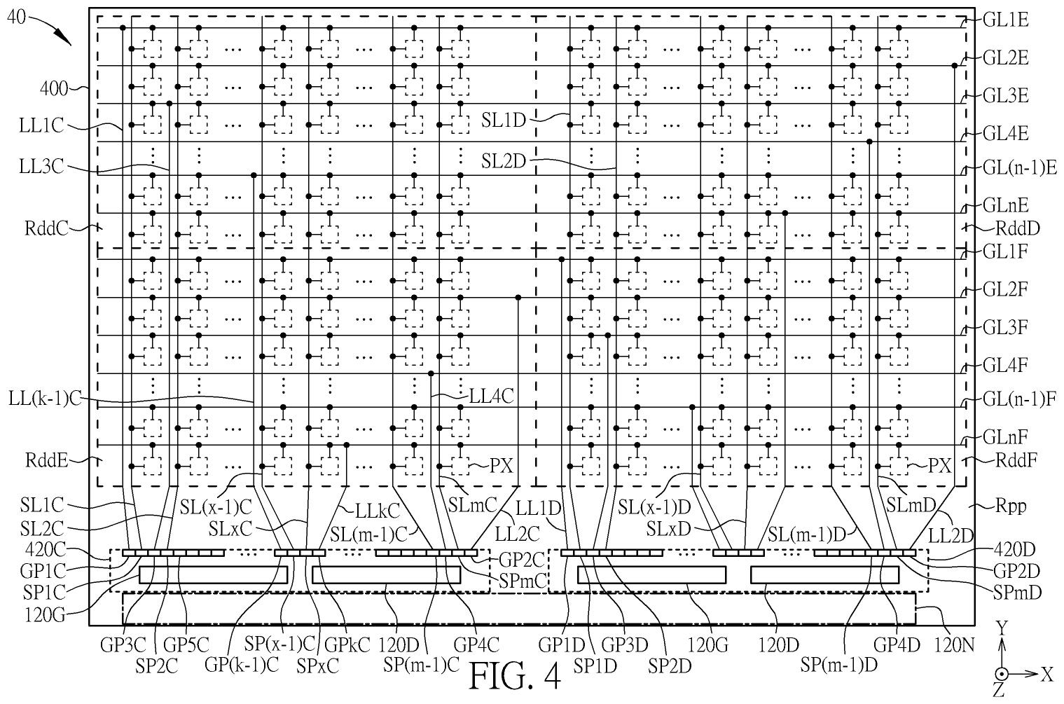

FIG. 4 is a diagram of a display device 40 of an embodiment of the present invention. A display panel 400 of the display device 40 may be divided into four display areas RddC-RddF. The configuration of the display areas RddC-RddF is substantially similar to the configuration of the display area Rdd, respectively, such that the display device 40 has a larger display size. Display panel driving chips 420C, 420D of the display device 40 are substantially similar to the display panel driving chips 320A, 320B, respectively, and may be utilized for driving the display areas RddC-RddF of the display panel 400. In some embodiments, the configuration of the display device 40 may improve the resolution (e.g., up to four times more) if compared to that of the embodiment in FIG. 1.

The display panel driving chips 420C and 420D collaboratively drive the display areas RddC-RddF of the display panel 400 closely adjacent to each other. Source lines SL1C-SLMC are located in the display areas RddC, RddE, which are closely adjacent in the Y direction, respectively. The source lines SL1D-SLMD are located in the display area RddD, RddF, which are closely adjacent in the Y direction, respectively. Gate lines GL1E-GlnE are located in both of the display areas RddC, RddD, which are closely adjacent in the X direction. Gate lines GL1F-GLnF are located in both of the display areas RddE, RddF, which are closely adjacent in the X direction. The source signal output ports SP1C-SPmC of the display panel driving chip 420C are respectively coupled to the corresponding source lines SL1C-SLmC in the display areas RddC, RddE. The source signal output ports SP1D-SPmD of the display panel driving chip 420D are respectively coupled to the corresponding source lines SL1D-SLmD of the display areas RddD, RddF.

The gate signal output ports GP1C-GPkC and the source signal output ports SP1C-SPmC of the display panel driving chip 420C are mutually interleaved; the gate signal output ports GP1D-GPkD and the source signal output ports SP1D-SPmD of the display panel driving chip 420D are mutually interleaved. Therefore, the gate signal output ports GP1C-GPkC of the display panel driving chip 420C may be connected to gate lines (e.g., the gate lines GL1E, GL3E, . . . , GL2F, GL4F) located in the display areas RddC and RddE via the connecting lines LL1C-LLkC, and the gate signal output ports GP1D-GPkD of the display panel driving chip 420D may be connected to gate lines (e.g., the gate lines GL2E, GL4E, . . . , GL1F, GL3F) located in the display areas RddD and RddF via the connecting lines LL1D-LLkD. In some embodiments, the sub pixels PX of the display areas RddC-RddF may be distributed continuously, such that there is no clear boundary between the display areas RddC-RddF.

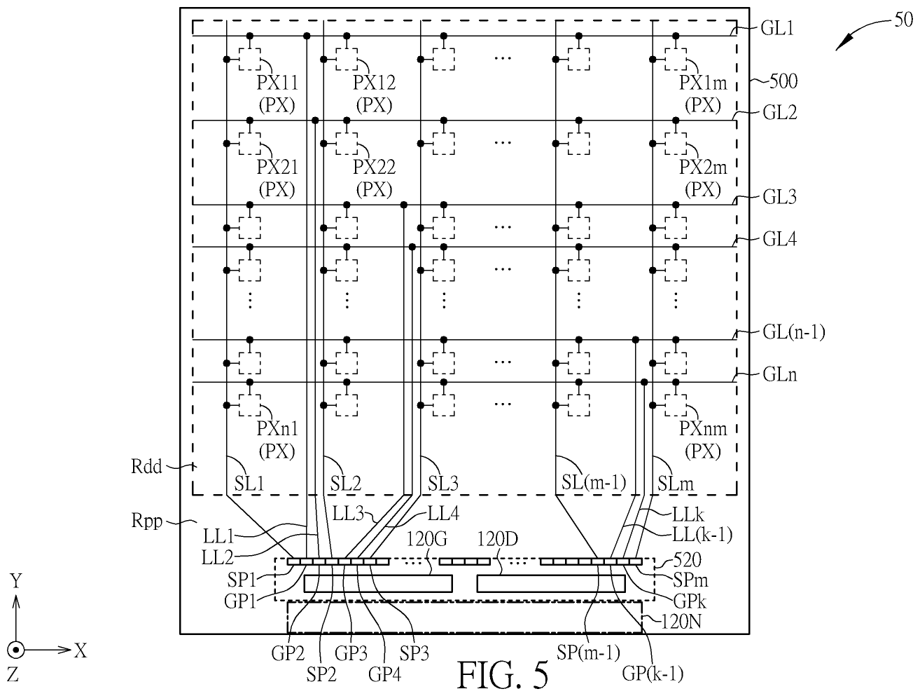

The arrangement of the gate signal output ports and the source signal output ports may be adjusted according to a ratio between the number of the source lines and the number of the gate lines. FIG. 5 is a diagram of a display device 50 of an embodiment of the present invention. The display device 50 is substantially similar to the display device 10.

In FIG. 5, two gate signal output ports (e.g., the gate signal output ports GP1, GP2) are disposed between any two adjacent or closest ones of the source signal output ports (e.g., the source signal output ports SP1, SP2). A source signal output port (e.g., the source signal output port SP2) is disposed between any two adjacent or closest ones of the gate signal output ports (e.g., the gate signal output ports GP2, GP3). Alternatively, there is no source signal output port disposed between two adjacent or closest ones of the gate signal output ports (e.g., the gate signal output ports GP1, GP2). The gate signal output ports GP1-GPk or the source signal output ports SP1-SPm may be arranged regularly but mutually interleaved.

In FIG. 5, since two gate signal output ports (e.g., the gate signal output ports GP1, GP2) are disposed between any two adjacent or closest ones of the source signal output ports (e.g., the source signal output ports SP1, SP2), the number of the gate signal output ports GP1-GPk is approximately twice as large as the number of the source signal output ports SP1-SPm; more specifically, k=2×m+1.

In some embodiments, the resolution of the display device may be 320×240; that is, there are 320 sub-pixels PX in the direction Y and 240×3 sub-pixels PX in the direction X to be arranged in an array. Accordingly, the number of the gate lines GL1-GLn is 320, and the number of the source lines SL1-SLm is 720. Correspondingly, the number of the source signal output ports SP1-SPm (which equals 720) exceeds twice the number of the gate signal output ports GP1-GPk (which equals 320). In this case, at least two source signal output ports may be disposed between any two adjacent or closest ones of the gate signal output ports.

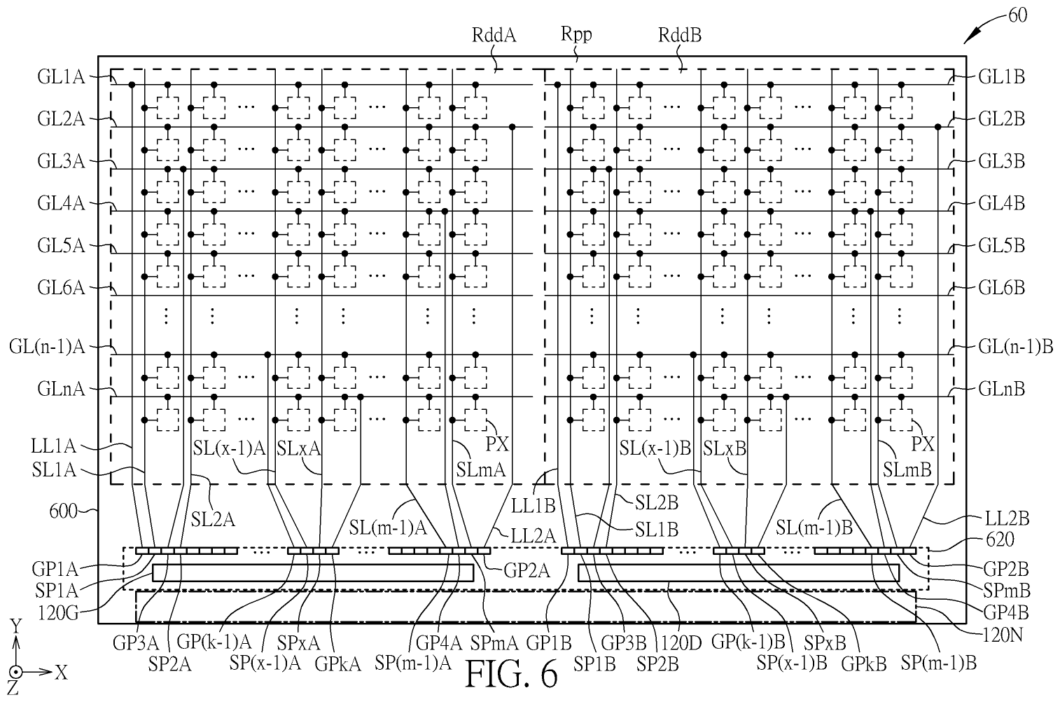

The number of the gate signal output ports may be greater than or equal to the number of rows of the sub-pixels PX of the display panel. FIG. 6 is a diagram of a display device 60 of an embodiment of the present invention. The display device 60 is substantially similar to the display device 30.

In FIG. 6, the gate lines GL1A-GlnA in the display area RddA are not connected to the gate lines GL1B-GlnB in the display area RddB. As a result, the driving load or power consumption of a display panel driving chip 620 may be reduced. In some embodiments, each of the gate lines (e.g., the gate line GL1A) in the display area RddA is aligned with one of the gate lines (e.g., the gate line GL1B) in the display area RddB. One gate line (e.g., the gate line GL1A) electrically connected to one connecting line (e.g., the connecting line LL1A) in the display area RddA may be located in the same row as one gate line (e.g., the gate line GL1B) electrically connected to one connecting line (e.g., the connecting line LL1B) in the display area RddB.

As set forth above, two gate signal output ports (e.g., the gate signal output ports GP1A, GP1B) of the display panel driving chip 620 of the display device 60 may be coupled to different gate lines (e.g., the gate lines GL1A, GL1B) in the same row. Therefore, two gate signal output ports (e.g., the gate signal output ports GP1A, GP1B) of the display panel driving chip 620 may output identical/similar gate signals. Accordingly, the number of the gate signal output ports GP1A-GPkA, GP1B-GPkB may be greater than or equal to the number of rows of the sub-pixels PX of the display panel 300.

In summary, the gate signal output ports and the source signal output ports of the present invention are mutually interleaved. As a result, the present invention prevents the source lines from crossing any connecting lines. The connecting lines span the display area and are coupled between the gate lines of the display panel and the display panel driving chip respectively, and hence the gate lines are coupled to the display panel driving chip in shorter paths. These may prevent the connecting lines from being distributed in the non-display areas on different sides of the display panel, thereby achieving narrow borders.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display panel driving chip, comprising:
a plurality of gate signal output ports, outputting a plurality of gate signals; and
a plurality of source signal output ports, outputting a plurality of source signals, wherein the source signal output ports and the gate signal output ports are interleaved.

2. The display panel driving chip of claim 1, wherein at least one of the gate signal output ports is disposed between two of the source signal output ports.

3. The display panel driving chip of claim 1, wherein at least one of the source signal output ports is disposed between two of the gate signal output ports.

4. The display panel driving chip of claim 1, wherein the gate signal output ports are respectively coupled to a plurality of connecting lines of a display panel, and the connecting lines pass through a display area of the display panel and are respectively coupled to a plurality of gate lines of the display panel, and an arrangement direction of the connecting lines located in the display area is the same with an arrangement direction of a plurality of source lines of the display panel, and the source signal output ports are coupled to the source lines.

5. The display panel driving chip of claim 1, wherein the gate signal output ports are coupled to a plurality of gate lines of a display panel, and the gate signal output ports are sequentially arranged according to row numbers of the coupled gate lines, or the gate signal output ports are arranged according to even row numbers and odd row numbers of the coupled gate lines, wherein gate signal output ports coupled to even-numbered gate lines are sequentially arranged on a side of the display panel driving chip, and gate signal output ports coupled to odd-numbered gate lines are sequentially arranged on another side of the display panel driving chip.

6. The display panel driving chip of claim 1 further comprising:
a gate driving circuit, coupled to the gate signal output ports, and generating the gate signals; and
a source driving circuit, coupled to the source signal output ports, and generating the source signals.

7. A display panel driving structure, comprising a plurality of display panel driving chips for driving a plurality of display areas of a display panel, wherein each display panel driving chip comprises:
a plurality of gate signal output ports, outputting a plurality of gate signals; and
a plurality of source signal output ports, outputting a plurality of source signals, wherein the source signal output ports and the gate signal output ports are interleaved.

8. The display panel driving structure of claim 7, wherein the display panel driving chips drive the display areas, respectively, and the gate signal output ports of the display panel driving chips are respectively coupled to a plurality of gate lines of the corresponding display areas, and the source signal output ports of the display panel driving chips are respectively coupled to a plurality of source lines of the corresponding display areas.

9. The display panel driving structure of claim 7, wherein the display panel driving chips collaboratively drive the display areas, the display areas are adjacent, and a plurality of gate lines are located in adjacent two display areas of the display areas, at least one gate line of the gate lines is located in both of the adjacent display areas, and a plurality of source lines are located in the display areas, the gate signal output ports of the display panel driving chips are respectively coupled to the gate lines, and the sources signal output ports of the display panel driving chips are respectively coupled to the source lines of the display areas.

10. The display panel driving structure of claim 7, wherein the gate signal output ports are respectively coupled to a plurality of connecting lines of the display panel, and the connecting lines pass through the display areas of the display panel and are respectively coupled to a plurality of gate lines of the display panel, and an arrangement direction of the connecting lines located in the display areas is the same with an arrangement direction of a plurality of source lines of the display panel, and the source signal output ports are coupled to the source lines.

11. The display panel driving structure of claim 7, wherein at least one of the gate signal output ports is disposed between two of the source signal output ports.

12. The display panel driving structure of claim 7, wherein at least one of the source signal output ports is disposed between two of the gate signal output ports.

13. A display device, comprising:
a display panel, comprising at least one display area, the display panel comprising:
a plurality of gate lines;
a plurality of source lines; and
a plurality of connecting lines, passing through the at least one display area and respectively coupled to the gate lines, wherein an arrangement direction of the connecting lines located in the at least one display area is the same with an arrangement direction of the source lines.

14. The display device of claim 13 further comprising:
at least one display panel driving chip, comprising:
a plurality of gate signal output ports, respectively coupled to the connecting lines; and
a plurality of source signal output ports, respectively coupled to the source lines, wherein the source signal output ports and the gate signal output ports are interleaved.

15. The display device of claim 14, wherein at least one of the gate signal output ports is disposed between two of the source signal output ports.

16. The display device of claim 14, wherein at least one of the source signal output ports is disposed between two of the gate signal output ports.

17. The display device of claim 14, wherein the at least one display panel driving chip drives the at least one display area, respectively, and the gate signal output ports of the at least one display panel driving chip are respectively coupled to the gate lines of the at least one corresponding display area via the connecting lines, and the source signal output ports of the at least one display panel driving chip are respectively coupled to the source lines of the at least one corresponding display area.

18. The display device of claim 14, wherein the at least one display panel driving chip comprises a plurality of display panel driving chips, the at least one display area comprises a plurality of display areas, and the display areas are adjacent, the display panel driving chips collaboratively drive the display areas, the gate lines are located in adjacent two display areas of the display areas, at least one gate line of the gate lines is located in both of the adjacent display areas, the gate signal output ports of the display panel driving chips are respectively coupled to the gate lines via the connecting lines, and the sources signal output ports of the display panel driving chips are respectively coupled to the source lines of the display areas.
